(19) United States
(12) Patent Application Publication
(10) Pub. No.: US 2011/0093385 A1
(43) Pub. Date: Apr. 21, 2011

(54) Customer Identification of Transactions and Financial Transaction Record Matching

(75) Inventors: Kathleen P. Minnis, Jacksonville, FL (US); David W. Woodacre, Charlton, MA (US); Cheryl T. Dipinto, Somers, CT (US)

(73) Assignee: BANK OF AMERICA CORPORATION, Charlotte, NC (US)

(21) Appl. No.: 12/689,046

(22) Filed: Jan. 18, 2010

Related U.S. Application Data
(60) Provisional application No. 61/252,391, filed on Oct. 16, 2009.

(51) Int. Cl. G06Q 40/00

(52) U.S. Cl. 705/39

(57) ABSTRACT

Financial institutions often process transactions on behalf of customers. The processing of these transactions may include the specification of a customer-specific identifier so that a customer receiving a record of the transaction is able to identify the transaction. For example, the customer-specific identifier may include a store number to help the customer identify a store from which the transaction originated. If the customer-specific identifier is not entered by the financial institution, a transaction case builder system may prompt a user for the identifier before the system will enter the transaction case data into a transaction processing system. The system may also transmit a pre-notification message to the customer alerting the customer to the transaction that is being processed. Furthermore, transaction processing may include matching transaction records and transaction advices regardless of whether the record and matching advice are received on the same day.

### CROSS REFERENCE TO RELATED APPLICATIONS

This application is a non-provisional application of and claims the benefit of priority from U.S. Application Ser. No. 61/252,391, entitled “CUSTOMER IDENTIFICATION OF TRANSACTIONS AND FINANCIAL TRANSACTION RECORD MATCHING,” filed Oct. 16, 2009.

### BACKGROUND

Processing of financial transactions is prone to error due to the substantial volume of transactions conducted on a daily basis and the speed with which the transactions must be processed due to customer expectations and demand. Consequently, adjustments are often necessary to correct any errors such as errors in deposit and withdrawal amounts. Currently, financial institutions make such adjustments with other financial institutions through various payment networks including the Federal Reserve and private financial clearinghouses. However, the payment networks generally issue two separate records for a transaction, the transaction record and a transaction advice. Because they are issued separately, the transaction record and the transaction advice must be matched up by the receiving financial institution before completing the adjustment. Many systems only recall the records and advices that have been received same-day. That is, records and advices that were received on a previous day cannot be matched with a record or advice received the next day. This creates a backlog of adjustments that must be handled separately and oftentimes, manually.

Additionally, customers affected by the adjustments will often need to perform their own research to identify a source or recipient of the adjustment. For example, retail companies that have many stores might need to identify the specific store from which the adjustment originated or to which the adjustment is owed. In such cases, the customer retail company might be required to manually identify such information based on analyzing financial records to match various pieces of information since a general store identifier or other customer-specific identifier is not provided for identification and sorting purposes.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, a customer-specific identifier is provided in a transaction case so that a customer receiving a record of the transaction is able to quickly and efficiently identify the transaction. For example, the customer-specific identifier may include a store number to help the customer identify a store from which the transaction originated. If the customer-specific identifier is not entered by the financial institution, a transaction case builder system may prompt a user for the identifier before the system will enter the transaction case data into a transaction processing system. Additionally or alternatively, the system may transmit a pre-notification message to the customer alerting the customer to the transaction that is being processed. In one or more arrangements, the customer-specific identifier may be provided by the customer in response to receiving the pre-notification message or in response to a query by the transaction case builder system.

According to another aspect, a customer system may receive pre-notification messages from a financial institution to create a transaction record on an internal account system (e.g., a general ledger). Upon receiving the final confirmation of the transaction, the customer system may automatically reconcile the transaction information and clear the general ledger. Transaction information may also be logged for each store based on a store identifier included in the transaction message or confirmation received from the financial institution.

According to yet another aspect, transaction records and transaction advices for adjustment transactions may be automatically matched by a financial case builder system regardless of whether the record and matching advice are received on the same day. If an advice cannot be matched with a record receiving on the same day, the advice may be warehoused for a specified period of time. Records may similarly be warehoused if a matching advice cannot be found on the same day. If multiple matches are found, the record or advice may be transmitted for additional research and analysis and no match may be confirmed.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example network environment for processing financial transactions according to one or more aspects described herein.

FIG. 3 illustrates an example data flow for generating a transaction case according to one or more aspects described herein.

FIG. 4 illustrates a method by which a financial institution may generate a transaction case and submit the case for processing according to one or more aspects described herein.

FIG. 5 illustrates a method by which a financial institution may store a customer-specific identifier into a transaction case according to one or more aspects described herein.

FIG. 6 illustrates an example user interface through which a user may view and edit transaction case information according to one or more aspects described herein.

FIG. 7 illustrates a method by which a customer system may automatically reconcile and log transactions according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

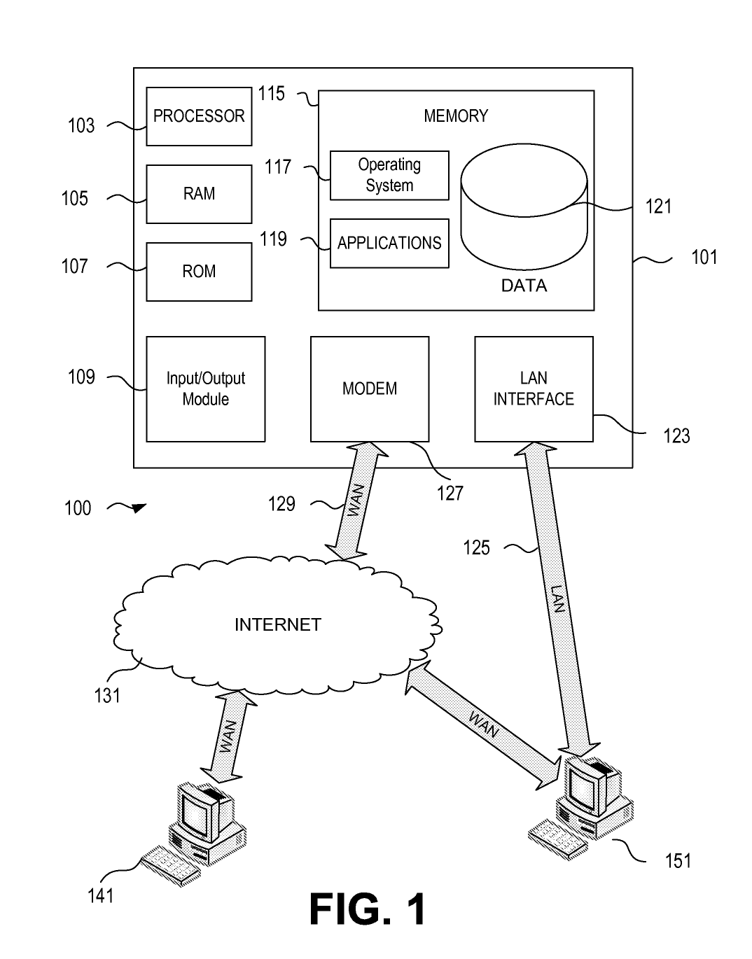

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The system, devices and networks of FIG. 1 may, in one or more arrangements, be used to provide check adjustment functionality. Check adjustments are used to resolve discrepancies between what is claimed as owed or paid and what is actually owed or paid. For example, a check adjustment may be needed where Bank A receives $100 from Bank B for a $1000 check deposited at Bank A. The error may result from a misread of the check, amount entry error, check reference number entry error or the like. Accordingly, an adjustment must be applied to the check transaction to compensate Bank A for the difference, i.e., $900. A system may be used to streamline the research and resolution of check adjustment cases. The system may provide automated workflow procedures for the entry and building of check adjustment cases, organization of check adjustment cases, creation of user interfaces for data entry, editing and viewing of case information including check images, interfacing with legacy and third party applications and the like. For example, the system may receive data from a transaction data collection system and automatically populate fields to build a transaction case.

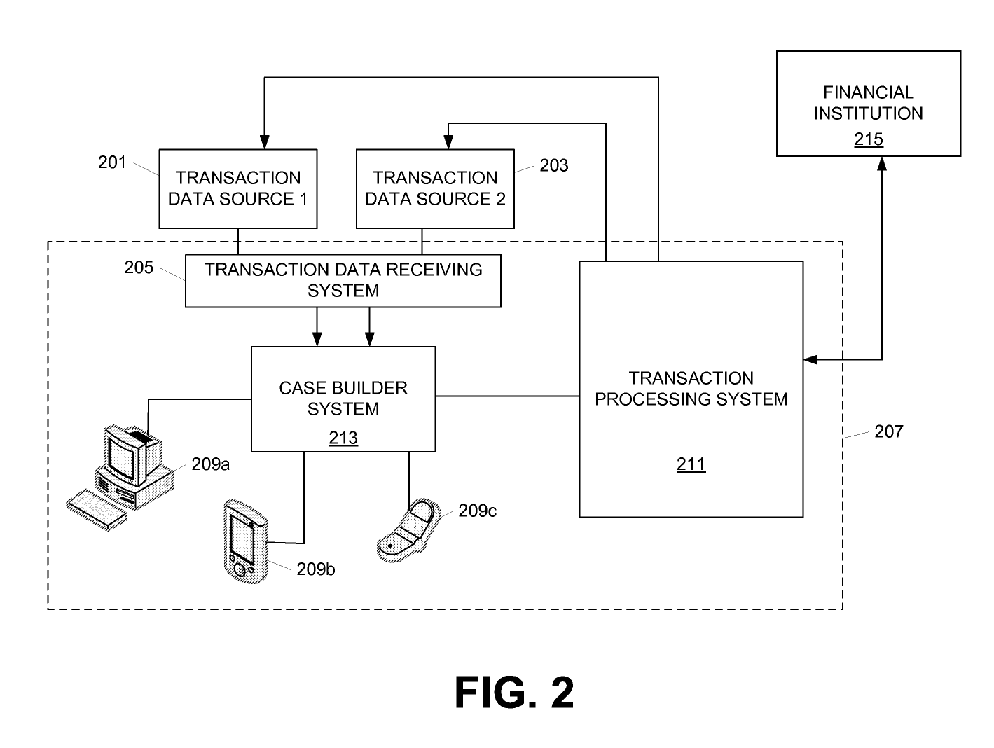

FIG. 2 illustrates a check adjustment intake and processing system. Check adjustment information and requests may be received from external sources 201 and 203. External sources 201 and 203 may include the Federal Reserve or other third party payment network systems. Check adjustment and other transaction information may be received from each of sources 201 and 203 through a wide area network such as the Internet by a transaction data receiving system 205. Transaction data receiving system 205 may be resident at the financial institution, e.g., institution 207, to which the transactions are directed or may be provided by a third-party. Transaction data receiving system 205 may include interfaces with one or more user terminals 209 configured to receive user input and interactions with the transaction information. For example, users may view, edit and/or otherwise manipulate the data for entry into a check adjustment resolution system such as system 211. In particular, transaction cases that are to be entered into system 211 may be created using case builder system 213. Thus, case builder system 213 may be configured to receive user instructions from terminals 209 and transaction data from sources 201 and 203.

System 211 may act as a data warehouse for check adjustment transaction information in addition to other types of transaction information. System 211 may further be configured to organize case information, facilitate the viewing and editing of transactions, send and receive information to and from various other systems and the like. For example, system 211 may transmit transaction information to external transaction data sources 201 and 203 including a third party payment network including government financial service systems such as the Federal Reserve upon resolution of a check adjustment request. In another example, system 211 may communicate with one or more other financial institutions (e.g., institution 215) to indicate that transactions such as check adjustments have been resolved or processed. In one or more arrangements each of system 211, user terminals 209 and transaction data receiving system 205 may be resident in financial institution 207.

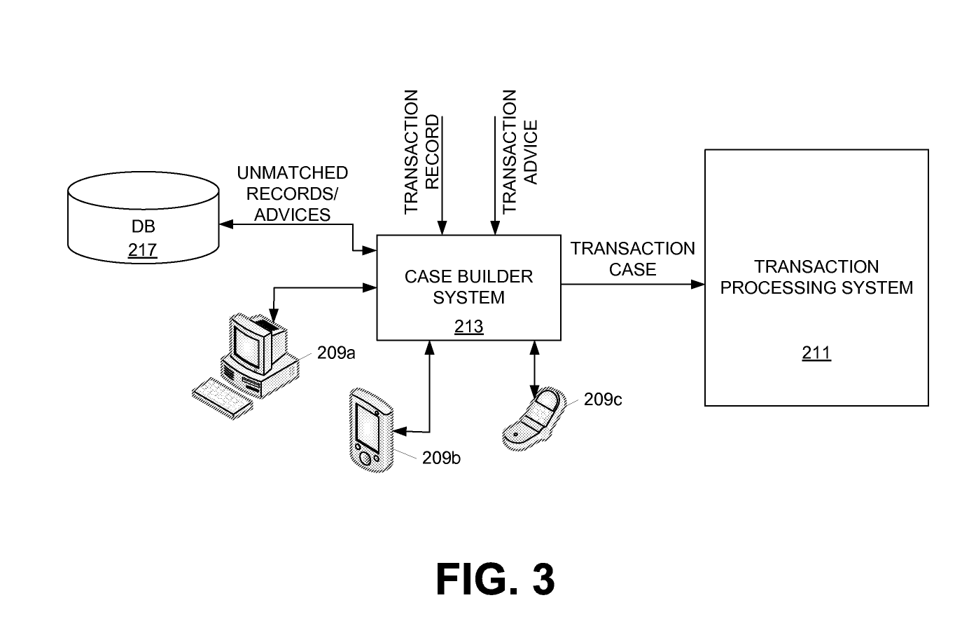

FIG. 3 illustrates a data flow by which transaction information may be received and matched by a case builder system such as case builder system 213. Case builder system 213 may generally be configured to structure and convert data into a format that is compatible with a transaction processing system such as system 211. Case builder system 213 may further be configured to automatically complete transaction records based on data received from external sources (e.g., sources 201 and 203 of FIG. 2). For example, transactions may include multiple types of information including a transaction record and a corresponding transaction advice that may be received at different times. The transaction record may include information relating to the transaction itself while the transaction advice includes other supplemental information for the transaction such as information for a customer affected by the transaction. Accordingly, in some arrangements, to build a transaction case, both the transaction record and the transaction advice may need to be entered.

Because the transaction record and the transaction advice may be received at different times, e.g., different days, case builder system 213 may warehouse either the transaction record or the transaction advice, whichever is first received, until the matching information is received. For example, case builder system 213 may store as-yet-unmatched transaction records and advices into database 217. Once a corresponding transaction record or advice is received, case builder system 213 may retrieve the stored transaction advice or record from database 217 and generate a case for the transaction. Generating a transaction case may further include manual input and/or review from user terminals 209. The case may then be inputted into transaction process system 211.

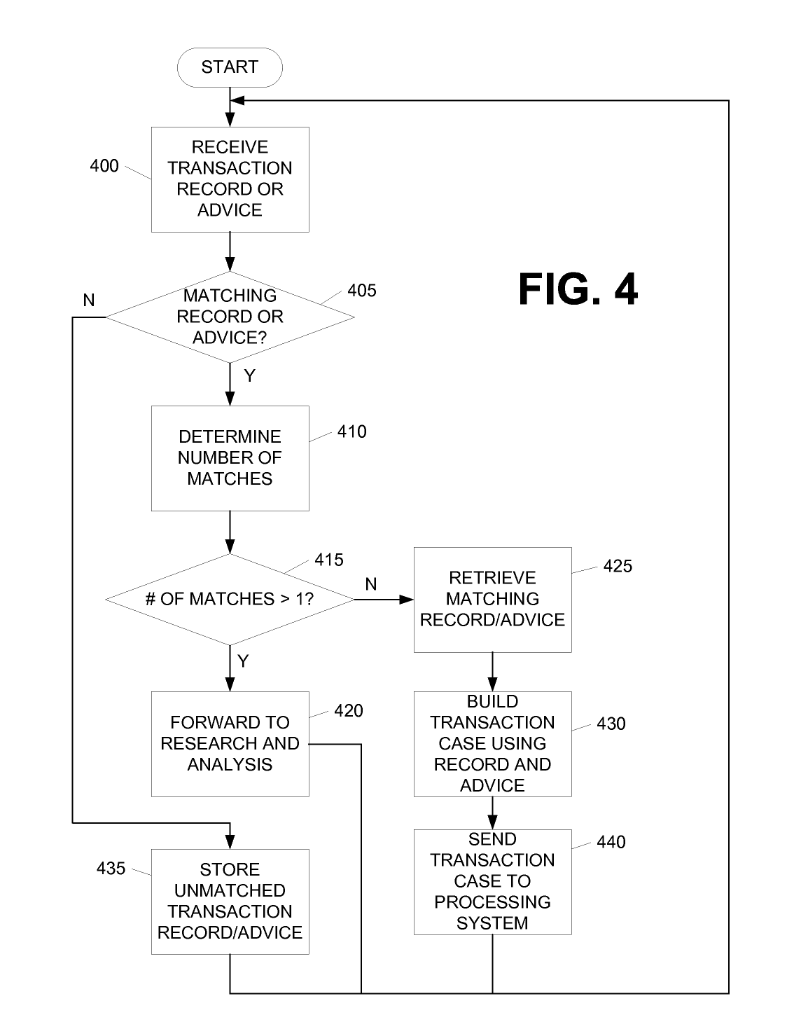

FIG. 4 illustrates a method by which transaction advices and transaction records may be matched to build a transaction case. In step 400, a case builder system may receive either a transaction record or a transaction advice. As discussed herein, transaction records and advices may be received from a variety of external sources including the Federal Reserve. In step 405, the case builder system may determine whether a matching transaction record or advice, as appropriate, has been received. The match may be determined using various information shared between transaction records and advices including an account identifier, amount of the transaction, a code or identifier (e.g., a 4 digit number or code) shared by the advice and transaction and/or combinations thereof. To qualify as a match, a transaction record and a transaction advice may be required to match a threshold number of parameters or fields. For example, the system may only determine a match between a record and an advice if the record and advice match 3 specified pieces of information.

In step 410, if the system determines that a matching record or advice has been received based on the matching processes of step 405, the system may determine a number of matches identified for the transaction record or advice in question. The system may then determine whether the number of matches is greater than 1 in step 415. If so, the system may transmit the transaction record and matching transaction advices or vice versa to a research and analysis department for further processing in step 420. Stated differently, a match might not be confirmed if multiple matches are found for a transaction record or advice.

If, however, the number of matches equals 1, the system may retrieve the matching record or advice in step 425. The system may then build a transaction case in step 430 using the information from the transaction record and matching transaction advice. Building the transaction case may include generating a data record or form including the requisite transaction information. The data record or form may conform to a template so that a transaction processing system may automatically parse the form and enter the data. The generated transaction case may subsequently be sent to a transaction processing center in step 440.

If, on the other hand, no matching transaction record or advice has been received or is found, the case builder system may store the transaction record or advice for which a match is sought in step 435. In some examples, transaction records and/or advices may be stored up for up 2 days so that matches can be identified for data received on the same day, the previous day or the day after. Other storage time limits may be defined per the requirements or needs of the financial institution and/or its clients. For example, transaction records may be stored for 5 days, a week, 2 weeks, a month, 2 months and the like. If a match is not found after the storage time limit is reached, the case builder system may send the non-matched transaction record or advice to research and analysis for further review, as illustrated in step 420.

Some clients for which check adjustments are processed in accordance with the features described herein may request that an identifier be assigned to the check adjustment transaction that corresponds to a internal client identifier. The identifier may be a transaction number, a store number (e.g., for retail chains), an account number and/or combinations thereof. The use of an identifier known by the client may allow the client to process check adjustment transactions more efficiently. For example, instead of manually reconciling adjustments, a client may use an automated reconciliation process that matches the identifier assigned to the transaction with an internal record of that same identifier along with other transaction identification information such as amount, check number, payee and the like.

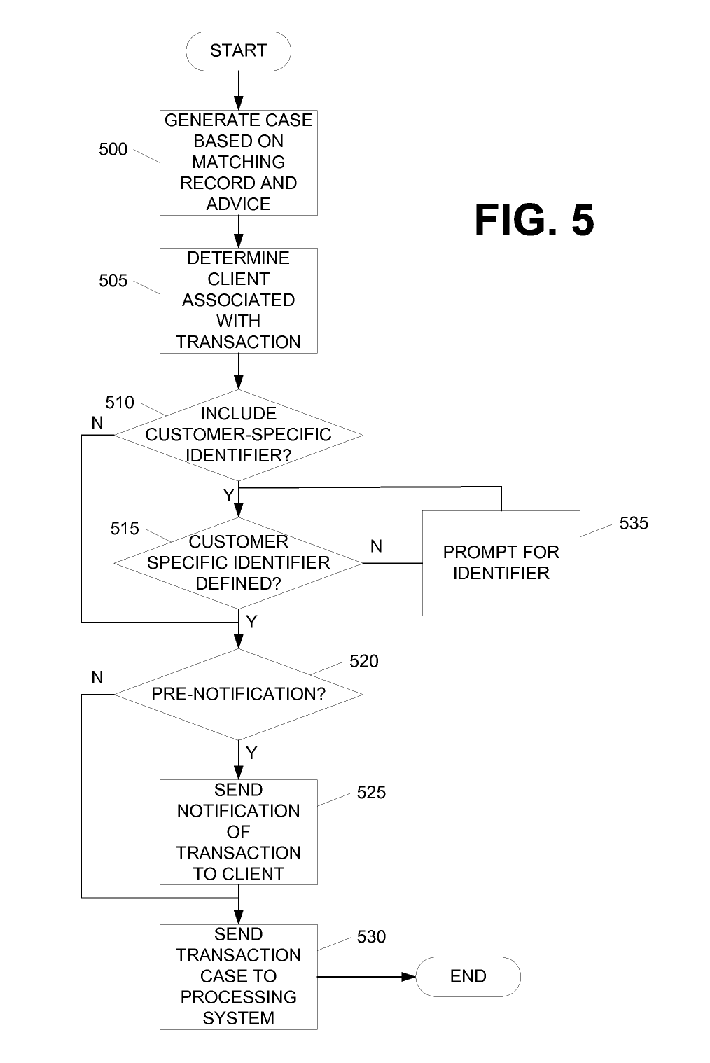

FIG. 5 illustrates a method by which a case builder system may build cases for transactions requiring customer-specific identifiers such as store numbers. Customer-specific identifiers generally refer to identifiers that are customer defined and/or shared between the customer and the case builder system. In step 500, the case builder system may generate a case using transaction record information and transaction advice. In step 505, the system may determine a customer or client associated with the transaction. For example, the customer or client may be the payor or payee of the check for which an adjustment is required. The customer or client may be identified in a database or look-up table based on a customer number, an account number, a name, contact information and/or combinations thereof. Once identified, the system may determine whether the customer wishes to include a customer-specific identifier in the transaction case in step 510. The determination may be made by examining a database of requested information that is keyed to a customer name or identifier or both. In one example, the system may determine that Customer A is involved with a check adjustment transaction. In response, the system may determine customer-specific information requested by Customer A for such transactions such as a store number indicating a store to which funds are to be paid or funds from which a check originated.

If customer-specific identifiers are requested, the system may determine whether the requested identifiers have been stored in the transaction case in step 515. If so, the system may further determine whether the customer has requested pre-notification of the transaction in step 520. Pre-notification may be flagged in the customer requested information database and retrieved in similar fashion to the types of customer-specific identifiers requested. If pre-notification is requested, notification of the transaction may be sent to the customer in step 525. Notification may be provided in various manners including by telephone, e-mail, postal mail, text message, status message (e.g., via TWITTER) and the like. The notifications may be generated and transmitted automatically by the system or may include manual processes (e.g., a personal telephone call). The notification may include transaction information such as a transaction identifier, transaction amount, store number (if relevant) and the like. If, pre-notification is not required or upon completion of pre-notification, the case may be forwarded to a transaction processing system in step 530.

If requested customer-specific identifiers have not been stored or provided in the transaction case, the system may prompt transaction entry personnel to provide the requested information in step 535. Alternatively or additionally, the system may attempt to retrieve and enter the requested identifiers automatically. For example, the system may identify a store number by cross-referencing an address used for the check with a customer list of stores, store numbers and store addresses. The system might not allow the case to be entered and submitted to the transaction processing system until the customer-specific identifiers have been entered. Once entered, the process may continue on to step 520.

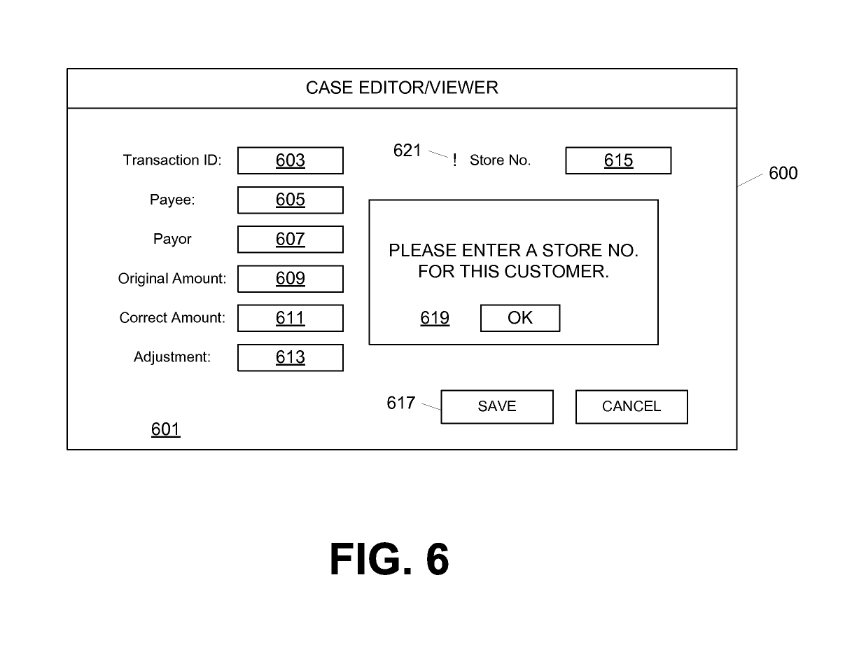

FIG. 6 illustrates an example user interface displaying a transaction case and a prompt requesting a customer-specific identifier. Interface 600 may be displayed at a terminal such as user terminal 205 of FIG. 2. Interface 600 may allow a user to define various fields of the transaction case 601 including transaction ID 603, payee 605, payor 607, original amount 609, corrected amount 611 and adjustment amount 613. Transaction case 601 may further include customer-specific identifiers or fields such as store identifier 615. When a user is finished building or editing case 601, the user may select save option 617 to close the viewing/editing interface 600 and send the case to a transaction processing system (e.g., processing system 211 of FIG. 2). However, if a customer-specific and requested identifier such as store identifier 615 has not been entered, as is the case in FIG. 6, a prompt 619 may be displayed requesting that the user address the deficiency. Additionally, the deficiency may be identified by marker 621.

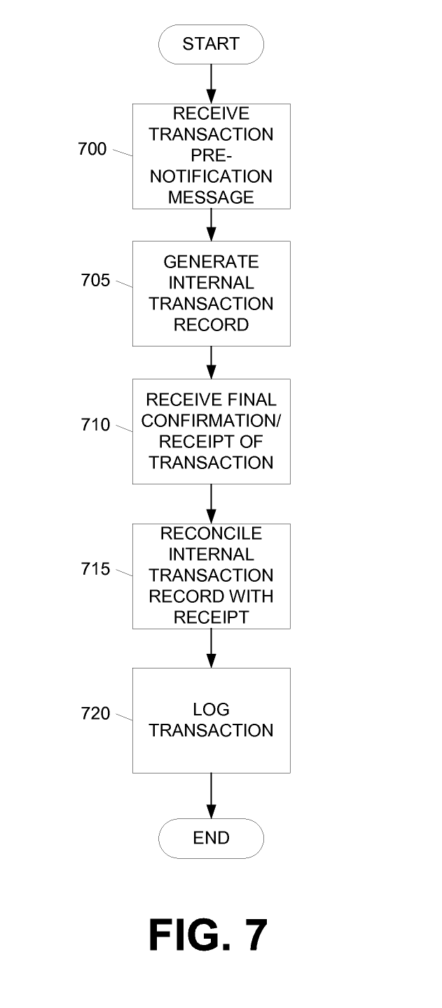

FIG. 7 illustrates a method by which a customer may process check adjustment transactions. In step 700, a customer may receive pre-notification of a check adjustment transaction. The pre-notification may be received by the customer system prior to the processing of the check adjustment transaction being completed at the financial institution holding the customer's account. In step 705, the customer system may generate an internal transaction record storing the transaction information along with a customer-specific identifier. In one or more configurations, the customer-specific identifier and the other transaction information may be extracted from the pre-notification. For example, the pre-notification may comprise an e-mail specifying various transaction information including the customer-specific identifier. Parsing may be performed with advanced knowledge of the notification format or, alternatively or additionally, identifying keywords within the notification message. Voice messages may be similarly parsed by initially converting the voice message from speech to text and subsequently parsing the converted text. The transaction record may include an entry on a customer's general ledger or account system indicating an amount to be deducted from the customer's account or a deposit to be expected into the customer's account.

In step 710, the customer system may receive a final confirmation or receipt of the check adjustment transaction. For example, the final confirmation may indicate that an unpaid amount has been deducted from the customer's account and transferred to a recipient account/entity. In another example, the final confirmation may indicate that a deficiency has been corrected by a supplemental deposit from a payee. In step 715, the customer system may reconcile the final confirmation with its transaction records. For example, reconciliation may be performed by matching various types of transaction data including the customer-specific identifier. Reconciliation may include removing the entry off the customer's general ledger or other account system upon receipt of the confirmation. In step 720, the transaction may further be logged based on the customer-specific identifier. For example, transactions may be stored and organized according to a store number for a retail company.

According to one or more aspects, the customer-specific identifier might not be included in the pre-notification. Instead, the customer may reply to a pre-notification with the customer-specific identifier. In one example, upon receiving a pre-notification call from the financial institution holding the customer's account, the customer may provide the financial institution with a customer-specific identifier. Alternatively, the customer system may automatically respond to pre-notification messages (e.g., email or text) with a customer-specific identifier. In one or more arrangements, the customer-specific identifier may include a randomly or pseudo-randomly generated customer-specific transaction identifier. Alternatively or additionally, the identifier may include a store number. The customer system may also prompt a user to manually specify an identifier upon receiving a pre-notification message from the financial institution.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method comprising:
receiving, at a financial institution system, data corresponding to a check adjustment transaction from a remote data source;
generating a transaction case for processing of the check adjustment transaction at the financial institution system;
determining whether the transaction case requires a customer-specific identifier shared between the financial institution system and a customer associated with the check adjustment transaction;
in response to determining that the transaction case requires the customer-specific identifier, determining whether the transaction case includes the customer-specific identifier; and
in response to determining that the transaction case does not include the customer-specific identifier, generating a prompt for the customer-specific identifier.

2. The method of claim 1, wherein determining whether the transaction case requires the customer-specific identifier includes:
determining the customer associated with the check adjustment transaction; and
retrieving required customer identifier information from a look-up table.

3. The method of claim 1, further comprising:
determining whether a pre-notification message of the check adjustment transaction is requested by the customer; and
in response to determining that the pre-notification message is requested, transmitting a message notifying the customer of the check adjustment transaction prior to the financial institution system completing processing of the check adjustment transaction.

4. The method of claim 3, wherein the pre-notification message includes a telephone call to the customer.

5. The method of claim 3, wherein the customer-specific identifier is received from the customer in response to the pre-notification message.

6. The method of claim 1, further comprising forwarding the transaction case to a transaction processing system upon determining that the customer-specific identifier is included in the transaction case.

7. The method of claim 1, wherein the customer comprises a plurality of retail stores and the customer-specific identifier comprises a store number of one of the plurality of retail stores.

8. The method of claim 1, wherein receiving the data corresponding to the check adjustment transaction from the remote data source includes:
receiving a transaction record at a first time; and
receiving a transaction advice corresponding to the transaction record at a second time.

9. The method of claim 8, further comprising
determining that the transaction advice has not been received at the first time; and
in response, storing the transaction record for a predefined storage time limit.

10. The method of claim 9, wherein the predefined storage time limit is two days.

11. An apparatus comprising:
a processor; and
memory operatively coupled to the processor and storing computer readable instructions that, when executed, cause the apparatus to:
receive data corresponding to a check adjustment transaction from a remote data source;
generate a transaction case for processing of the check adjustment transaction at a financial institution system;
determine whether the transaction case requires a customer-specific identifier shared between the financial institution system and a customer associated with the check adjustment transaction;
in response to determining that the transaction case requires the customer-specific identifier, determine whether the transaction case includes the customer-specific identifier; and
in response to determining that the transaction case does not include the customer-specific identifier, generate a prompt for the customer-specific identifier.

12. The apparatus of claim 11, wherein receiving the data corresponding to the check adjustment transaction from the remote data source includes:
receiving a transaction record at a first time; and
receiving a transaction advice corresponding to the transaction record at a second time.

13. The apparatus of claim 12, further comprising
determining that the transaction advice has not been received at the first time; and
in response, storing the transaction record for a predefined storage time limit.

14. The apparatus of claim 13, wherein the predefined storage time limit is two days.

15. One or more computer readable media storing computer readable instructions that, when executed, cause an apparatus to:
receive data corresponding to a check adjustment transaction from a remote data source;
generate a transaction case for processing of the check adjustment transaction at a financial institution system;
determine whether the transaction case requires a customer-specific identifier shared between the financial institution system and a customer associated with the check adjustment transaction;
in response to determining that the transaction case requires the customer-specific identifier, determine whether the transaction case includes the customer-specific identifier; and
in response to determining that the transaction case does not include the customer-specific identifier, generate a prompt for the customer-specific identifier.

16. The one or more computer readable media of claim 15, wherein determining whether the transaction case requires the customer-specific identifier includes:
determining the customer associated with the check adjustment transaction; and
retrieving required customer identifier information from a look-up table.

17. The one or more computer readable media of claim 15, wherein the computer readable instructions, when executed, further cause the apparatus to:
determine whether a pre-notification message of the check adjustment transaction is requested by the customer; and
in response to determining that the pre-notification message is requested, transmit a message notifying the customer of the check adjustment transaction prior to the financial institution system completing processing of the check adjustment transaction.

18. The one or more computer readable media of claim 17, wherein the pre-notification message includes a telephone call to the customer.

19. The one or more computer readable media of claim 15, wherein the customer comprises a plurality of retail stores and the customer-specific identifier comprises a store number of one of the plurality of retail stores.

20. The one or more computer readable media of claim 15, wherein receiving the data corresponding to the check adjustment transaction from the remote data source includes:
receiving a transaction record at a first time; and
receiving a transaction advice corresponding to the transaction record at a second time.
